(19) United States
(12) Patent Application Publication
(10) Pub. No.: US 2010/0280874 A1
(43) Pub. Date: Nov. 4, 2010

(54) MOBILE DEVICE, NETWORK SERVER AND METHOD FOR EVALUATING CORRELATION BETWEEN ADVERTISEMENT INFORMATION AND USER BEHAVIOR

(75) Inventor: Karl Ola THORN, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/432,183

(22) Filed: Apr. 29, 2009

(51) Int. Cl. G06Q 30/00; H04W 4/02; G06Q 10/00

(52) U.S. Cl. 705/10; 455/456.3; 705/26; 705/14.58

(57) ABSTRACT

The present invention relates to a mobile device, network server and method for evaluating a correlation between advertisement information and the behavior of a user having received the advertisement information to verify the effectiveness of providing advertisement information to a user directly without having a user to take a survey. The method comprises providing advertisement information to the user, maintaining an association between said advertisement information and business location data indicative of at least one location of a business, obtaining mobile device location data about the current location of a mobile device of the user, comparing said mobile device location data with said business location data, and if the comparing step determines that said mobile device location matches with a business location indicated in said business location data, registering the match.

### FIELD OF THE INVENTION

The present invention relates to a mobile device, network server and method for evaluating a correlation between advertisement information related to advertised goods or services and the behavior of a user having received the advertisement information, in particular, on a mobile device.

### BACKGROUND

Mobile advertising, i.e. advertising via mobile devices, is constantly increasing with the increase in usage of mobile devices. For example, in some countries mobile phone usage has already overtaken the fixed line phone usage and in most countries more mobile phones exist than computers connected to the Internet. Furthermore, there is a large variety of mobile devices available for making telephone calls, surfing the Internet, listening to music, taking pictures, determining a location, etc. In recent years, these functions have not only been provided individually on a single device but have been combined in multifunctional devices, such as smart phones.

Advertisement information may be provided via a cellular communication network, WLAN hotspots or a WiMAX hotzone and thus several different mobile devices may be a target for mobile advertisement.

In the past, the non-mobile Internet has shown that earning money on advertising is difficult since the users' response to an advertisement is hard to measure. Some websites use the users' clicks on advertisements as an indicator of the success of an advertisement in directing a user to another website, usually the website of the advertising business.

In the real word, physical stores usually attract people with signs or handouts, such as vouchers, to drive them into their store. It is clear that the success of advertising strongly depends on whether a potential customer seeing or hearing the advertisement visits the store and particularly whether the customer buys something in the store.

Conventionally, such a success is measured by carrying out a survey, e.g. by questioning people on the telephone, on the street or on the Internet about their behavior and preferences. These surveys are largely considered annoying by most people and if a survey is answered, for example only because a reward is promised, the result may be unreliable since the user's only intention may have been to receive the reward.

Although providing such a survey on the Internet or in another electronic form, such as e-mail or SMS, which may provide some form of technical automation, the user's cooperation is still needed.

Therefore, there is a need for verifying the effectiveness of providing advertisement information to a user directly without a user having to take a survey or take part in another form of questioning.

### DISCLOSURE OF INVENTION

A mobile device, network server and method for evaluating a correlation between advertisement information and the behavior of a user having received the advertisement information are presented, which use a comparison of the user's location and the location of the business that has been advertised.

An embodiment of the invention provides a method for evaluating a correlation between advertisement information related to advertised goods or services and the behavior of a user having received said advertisement information. The method comprises the steps of providing advertisement information to the user, maintaining an association between said advertisement information and business location data indicative of at least one location of a business, where goods or services subject to advertisement information are available for purchase, obtaining mobile device location data about the current location of a mobile device of the user after said advertisement information has been provided, and comparing said mobile device location data with said business location data indicative of said at least one location of the business. Subsequently, if the comparing step determines that said mobile device location matches with a business location indicated in said business location data, the match is registered.

Accordingly, the behavior, i.e. the movement after obtaining advertisement information, of a user may be monitored and the effectiveness of the advertisement information may be checked by comparing the location of the mobile device of the user and the locations of the businesses where goods or services advertised through the advertisement information are available for purchase. A direct interaction with the user using a survey or other forms of questioning the user is thus not needed and more reliable results may be obtained.

According to a further embodiment, the method comprises the step of storing at least one of the provided advertisement information and said business location data in the mobile device or network servicing the mobile device to keep track of the previously provided advertisement information. Accordingly, the history of advertisement information provision may be stored and compared to the movement of the user, for example during 24 hours.

According to a further embodiment, at least one of the provided advertisement information and the business location data is stored in a cookie in the mobile device. Accordingly, existing hardware and software infrastructure may be used simplifying implementation of the method in present mobile devices.

According to a further embodiment, the step of registering the match comprises writing an indication of the match into a cookie, and the method further comprises sending the cookie from the mobile device to a network server. Accordingly, an indication of the match can be transferred easily in a network so that a network server can register the match or matches.

According to a further embodiment, the advertisement information is stored in encrypted form. Accordingly, the history of advertisement information provision cannot be manipulated ensuring correctness of the matches and data security.

According to a further embodiment, the advertisement information is provided based on the location of the mobile device. Accordingly, location dependent advertisement may be selectively provided to the user, i.e. advertisement information that is chosen based on the location of the user of the mobile device can be provided, such as the locations of nearby restaurants.

According to a further embodiment, the method comprises the step of providing advertisement information regarding a particular business upon user request. Accordingly, advertisement information is, for example, provided following an active search by the user so as to increase the probability that the provided information is appreciated and the user visits a business associated with the information.

According to a further embodiment, the method further comprises the step of counting the number of matches between mobile device locations and business locations, wherein a reward paid by the business depends on the number of matches. Accordingly, a simple accounting scheme can be introduced in which the success of advertisement information can be correlated with the number of matches and an advertiser can be rewarded by the advertising businesses accordingly.

According to a further embodiment, the method further comprises the step of repeatedly updating the association between the advertisement information and business location data. Accordingly, a correlation may still be evaluated, even if the business is a mobile business changing its position day by day or hour by hour, such as a market stand or an ice-cream van, respectively.

According to an embodiment, a mobile device for evaluating a correlation between advertisement information related to advertised goods or services and the behavior of a user having received the advertisement information is provided. The mobile device comprises an information providing section for providing advertisement information to the user of said mobile device, wherein said advertisement information is associated with business location data indicative of at least one location of a business, where goods or services subject to advertisement information are available for purchase, a business location data receiving section for receiving business location data associated with said provided advertisement information, and a location obtaining section for obtaining mobile device location data about the current location of the mobile device. Further, the mobile device comprises a comparing section for comparing said mobile device location data with said business location data indicative of said at least one location of the business, and a registering section for registering a match, if the comparing section determines that the mobile device location matches with a business location indicated in the business location data.

Accordingly, the success of providing advertisement information may be checked by evaluating a correlation between advertisement information and the behavior of the user having received the information.

According to a further embodiment, the mobile device further comprises a first storage section for storing at least one of the provided advertisement information and the business location data in the mobile device or network serving the mobile device to keep track of the previously provided advertisement information. Accordingly, the history of advertisement information provision may be monitored. Similarly, the business location data may be monitored which is associated with the advertisement information and thus both the advertisement information and business location data can be used to determine whether the position of the mobile device of a user matches with a location of a business for which advertisement information has been provided.

According to a further embodiment, the mobile device further comprises a second storage section for storing an association between the advertisement information and business location data. Accordingly, when comparing the mobile device location data with the business location data in the comparing section, the mobile device may only refer to the second storage section to obtain the business location data associated with previously provided advertisement information thus increasing the speed of the comparison.

According to a further embodiment, the mobile device is a mobile phone operating in a mobile communication network.

According to an embodiment, a network server for evaluating a correlation between advertisement information related to advertised goods or services and the behavior of a user having received said advertisement information is provided. The network server comprises an information providing unit for providing advertisement information to a mobile device of the user, a storage unit for storing an association between the advertisement information and business location data indicative of at least one location of a business, where goods or services subject to advertisement information are available for purchase, and a location obtaining unit for obtaining mobile device location data about the current location of the mobile device. The network server further comprises a comparing unit for comparing the mobile device location data with location data indicative of the at least one location of the business, and a registering unit for registering a match, if the comparing unit determines that the mobile device location matches with a business location indicated in the business location data.

Accordingly, a network server may provide similar advantages as the mobile device, namely the network server may evaluate a correlation between advertisement information related to advertised goods or services and the behavior of a user having received the advertisement information. Furthermore, since the network server provides usually high data security, the correlation may be evaluated without jeopardizing the mobile device user's private information.

According to a further embodiment, the network server comprises a counting unit for counting the number of matches between mobile device locations and business locations. Accordingly, a reward may be paid to an advertiser managing the provision of advertisement information depending on the number of matches and thus the effectiveness of the advertisement.

According to an embodiment, a computer program product is provided which, when loaded into a program memory of a processor or microcontroller, causes the processor or microcontroller to execute one of the methods described above.

### BRIEF DESCRIPTION OF THE DRAWINGS

FIG. 1 illustrates operations of a method for evaluating a correlation between advertisement information and user behavior according to an embodiment of the invention.

FIG. 2 illustrates a mobile device and elements thereof according to an embodiment of the invention.

FIG. 3 illustrates a method for evaluating a correlation between advertisement information and user behavior according to an embodiment of the invention, in particular describing the use of a cookie.

FIG. 4 illustrates a practical example of using the method of FIG. 1 and/or the mobile device of FIG. 2.

FIG. 5 illustrates another practical example using the method of FIG. 1 and/or the mobile device of FIG. 2.

FIG. 6 illustrates a network server and elements thereof according to an embodiment of the present invention.

### DETAILED DESCRIPTION OF THE PREFERRED EMBODIMENTS

Preferred embodiments of the invention are described with reference to the figures. It is noted that the following description contains examples only and should not be construed as limiting the invention.

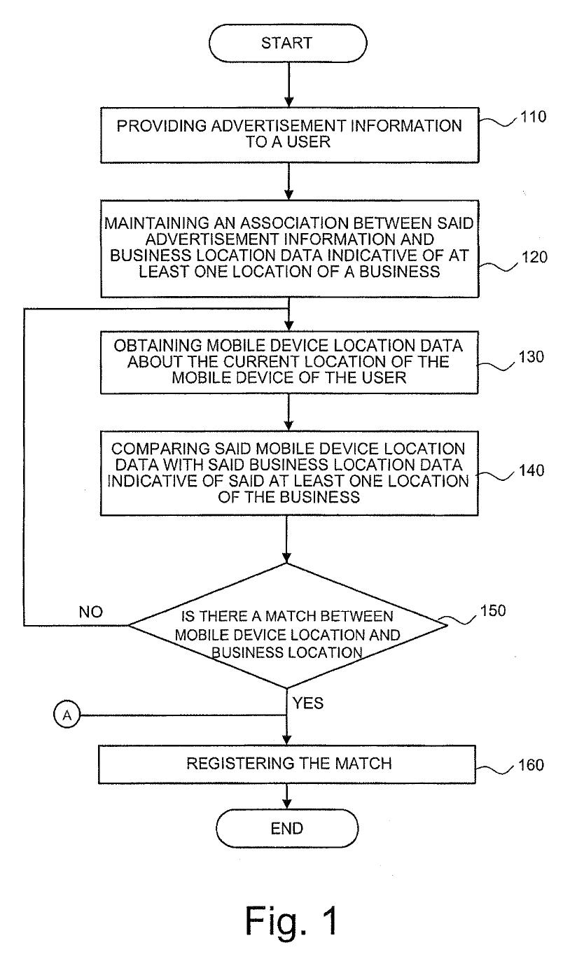

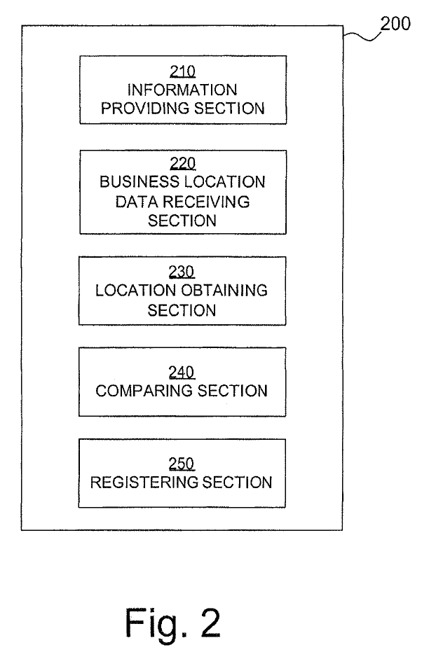

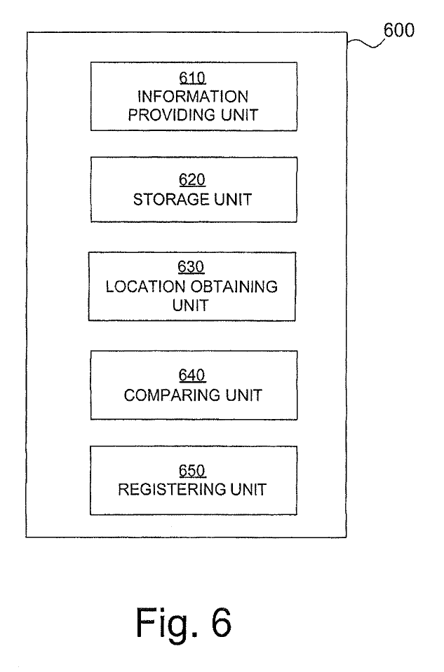

FIG. 1 illustrates a method for evaluating a correlation between advertisement information related to advertised goods or services and the behavior of a user having received the advertisement information. From the following description, it should be understood that the herein discussed method can be carried out on a mobile device, such as the mobile device shown in FIG. 2 or some kind of server, such as the network server shown in FIG. 6, but is not limited thereto. For example, some of the steps of the method may be carried out on a mobile device, whereas other steps may be carried out on a network server so that various implementation possibilities of the herein described methods exist.

At first, the method shown in FIG. 1 will be described in its generality, and later specific examples will be given.

In a first step 110, advertisement information is provided to a user. Advertisement information is information related to goods or services offered by a business which advertises the goods or services, for example, through an advertiser, such as an advertising agency on a network serving mobile devices. For example, advertisement information indicates special offers of a fast food restaurant, wherein the mobile device may be a mobile phone receiving the advertisement information through a mobile communication network, such as GSM, GPRS, UMTS, or similar, which may also provide a connection to the Internet. Accordingly, the mobile device may receive advertisement information from the network and provide this advertisement information to the user of the mobile device by outputting it on a display or loudspeaker of the mobile device.

Further, in step 120, an association is maintained between the advertisement information and business location data indicative of at least one location of business, where goods or services subject to advertisement information are available for purchase. The business location data is not limited to only one location of a business. For example, in the case of fast food restaurants, these restaurants often belong to a chain with more than one location. Therefore, it is feasible that one advertisement, for example for food, is associated with several locations of the same fast food restaurant. The business is clearly not limited to restaurants but may be any point of sale or shop interested in attracting potential customers by advertising.

Clearly the term advertising should be understood broadly, since the advertisement information may also be constituted by a simple entry of the business in the yellow pages or similar directory so that a user searching for some kind of nearby business, e.g. a hardware store, receives the address and/or telephone number of a nearby hardware store as “advertisement information”, for example. Here, a business may pay a fee to be on the top of the search listing.

In a specific example, the user may request to obtain information regarding food places, uses his/her mobile phone and searches the Internet or other network for food places. Then, advertisement information regarding the particular business, such as fast food restaurants, is provided, wherein the location of the mobile phone may be taken into account so that the user receives information on fast food restaurants in the user's vicinity, e.g. up to 1 km distance of the user. Here the information may provide the address of these restaurants but it may also be sufficient to inform the user of the existence of the restaurants in the vicinity and possibly a rough indication where to go to find them as long as an association between the advertisement information and business location data, e.g. the locations of the fast food restaurants in the vicinity, is maintained somewhere in the network or mobile device.

After the advertisement information has been provided, upon request as discussed above or also through passive consumption through random advertisements on the mobile device, mobile device location data about the current location of the mobile device is obtained in step 130.

There are several possibilities of obtaining mobile device location data, i.e. the location, such as the coordinates of the mobile device of the user, for example by using GPS (Global Positioning System) which may be integrated in the mobile device by a GPS signal receiving device or triangulation when using mobile phones. Therefore, location changes of the user may be monitored and it may be determined whether the movement of the user is affected by the provided advertisement information as discussed below.

To evaluate whether there is a correlation between advertisement information and user's behavior, the mobile device location data is compared in step 140 with the business location data indicative of the at least one location of the business. As described above, there is an association between business location data and advertisement information. For example, if the advertisement information is associated with the locations of ten fast food restaurants, it may be determined whether the location of one of the restaurant matches with the mobile device location. The association may be provided by a simple look-up table including advertisement information of a business and the corresponding location(s) of that business.

Generally speaking, when evaluating a correlation, it is determined whether there is a match between the mobile device location and at least one location of the business, as shown in step 150 of FIG. 1. If there is no match, the process flow returns to step 130 to further monitor the movement of the user of the mobile device to determine whether there is maybe a match at a later time. For example, the location of the mobile device can be obtained every 2 minutes and compared to the previously provided advertisement information.

If there is a match between the mobile device location and a business location, as shown in step 150, this match is registered in step 160 and the process ends.

If at any point in time, new advertisement information is provided, the process starts again carrying out the method steps 110 to 160. It is noted that at the same time, several processes for different advertisement information may be carried out while the current location of the mobile device of the user obtained may be used for these different processes.

In the following, FIG. 2 illustrates elements of a mobile device 200 according to an embodiment of the invention. The mobile device 200 comprises elements to carry out functions similar to the method steps described above with respect to FIG. 1. In detail, the mobile device 200 comprises an information providing section 210, a business location data receiving section 220, a location obtaining section 230, a comparing section 240 and a registering section 250. These elements are connected to each other to achieve the herein discussed functions.

As will be discussed below, the mobile device 200 is able to evaluate a correlation between advertisement information and user behavior such as the movement pattern of the user. The mobile device 200 may be a mobile terminal, mobile phone, personal digital assistant (PDA), portable computer, netbook, or any other similar device that is adapted to receive information through a network and may be localized via GPS or determination of its serving node, e.g. WLAN node or base station (BS), to which it can be connected.

The information providing section 210 provides advertisement information to the user of the mobile device 200, which has been received previously by the mobile device, preferably wirelessly through a network. The information providing section 210 may be a display or loudspeaker or a combination thereof producing visible and/or audible output. The advertisement information may be received by any kind of receiving or transceiving section in the mobile device 200, such as common interfaces for mobile communication or WLAN communication according to the IEEE 802.11 standard known to the skilled person.

Similar to the above, an association is maintained between the advertisement information and business location data indicative of at least one location of a business, where goods or services subject to advertisement information are available for purchase. This association may be maintained on the mobile device itself, for example in a storage section of the mobile device or somewhere else on the network so that an association between particular advertisement information and business location data may be queried if needed.

Further, the mobile device 200 is provided with a business location data receiving section 220 for receiving business location data associated with the provided advertisement information. The business location data receiving section 220 may refer to the storage section in which the association between advertisement information and business location data is kept to obtain the location(s) associated with the provided advertisement information. This may be performed by simply receiving the business location data from the mobile device itself or by searching in the network for an association.

The location obtaining section 230 is provided for obtaining mobile device location data about the current location of the mobile device 200. The location obtaining section 230 may be a GPS device for obtaining the coordinates of the location using GPS signals from satellites. However, the location obtaining section 230, for example in the case of a mobile phone, may communicate with one or more base stations of a mobile communication network, which have known locations and may use triangulation to determine the location of the mobile phone without the need that the mobile phone actively carries out a measurement. Several network-based techniques from simple cell identification as the least accurate and triangulation are known, whereas triangulation may be highly accurate by using time of arrival (TOA) or time difference of arrival (TDOA) or both to further enhance the accuracy of the location. In TDOA, the network determines the time difference and therefore the distance from each base station to the mobile phone and in TOA, the absolute time of arrival at a certain base station rather than the difference between two stations is used. Similarly, also WLAN (sometimes also referred to as Wi-Fi) nodes can be used to obtain the position of the mobile device 200 or in other types of networks the closest antenna.

Once mobile device location data and business location data is available, the comparing section 240 compares the mobile device location data with the business location data similar to step 140 and step 150 described above. If the comparing section 240 determines that the mobile device location matches with a business location indicated in the business location data, the registering section 250 registers the match.

To keep track of previously provided advertisement information, a storage section may be provided for storing at least one of the provided advertisement information and the business location data. This storage section may be the same storage section as the one for storing the previously discussed association in the mobile device or may be another storage section provided somewhere in the network serving the mobile device 200.

It is noted that storing one of the provided advertisement information and the business location data may be enough since an association between both exists. Further, it may be useful to also store an indication of the advertiser providing the advertisement information in the network if more than one advertiser exists in the network to determine which advertiser provided the advertisement information for which a match has been registered. The advertiser may be different from the network operator, which is especially clear in the context of using a browser on a mobile phone accessing the Internet via a mobile communication service, such as UMTS, in which the advertiser is advertising on the Internet.

Business location data may also be stored as one or more geotags, wherein coordinates are embedded into media such as digital photographs via geotagging. Coordinates of business location data may be stored as latitude and longitude coordinates but also altitude is feasible so that a business on a first floor may be differentiated from a business on the second floor, whereas the location may be compared to the mobile device location, which may also include information on the altitude which can be obtained via GPS, for example. Therefore, the mobile device 200 may obtain the history regarding previously provided advertisement information by accessing the storage section, obtain business location data associated with the advertisement information and compare the business location data with mobile device location data.

To evaluate a correlation between the advertisement information and the behavior of the user, the elements of the mobile device 200 are suitably connected with each other. For example, the business location data receiving section 220 is coupled to the information providing section 210 so that it may be easily determined which business location data corresponding to which advertisement information needs to be obtained, whereas the comparing section 240 is coupled to the business location data receiving section 220 and the location obtaining section 230 to obtain the necessary data to carry out the comparison. Further, the registering section 250 is coupled to the comparing section 240 to register the match.

According to a specific embodiment, the provided advertisement information and/or the business location data is stored in a cookie in the mobile device 200. Further, also an indication of the advertiser, e.g. its name or identification number, may be stored in a cookie.

As known in the art, a cookie may be a small piece of text stored by a web browser usually containing user setting information, previously visited websites, user entries on websites or other data used by websites. Alternatively or additionally, at least one of advertisement information, business location data and indication of an advertiser is stored in the cookie so that this information is easily sharable between a mobile device and a network server, for example.

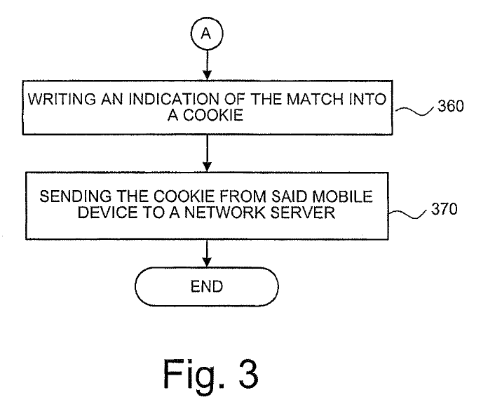

As shown in FIG. 3, an indication of the match may be written into the cookie as part of the match registration process, as indicated in step 360. Subsequently, in response to the match and the registration, the cookie may be sent from the mobile device to a network server, as indicated in step 370, wherein the network server may keep track of a plurality of cookies from one or more mobile devices related to a plurality of matches.

By evaluating the number of matches and the different advertisers providing the advertisement information related to the matches, a reward for each advertiser may be determined. For example, the higher the number of matches, the higher the reward for the advertiser. The reward may further increase if it is determined that the user attracted by the advertisement bought something at the visited business.

To increase the privacy of the user, all data stored in a storage section of the mobile device or the network, or stored in a cookie which may be stored in said storage section, is preferably encrypted. Therefore, even if data stored on the mobile device or transferred between the mobile device and the network is obtained by a third party, it will be difficult for the third party to derive the user's behavior, such as visited locations as well as the advertisement information provided to the user.

For encrypting the data, e.g. the data in the cookie, a public key/private key encryption may be used. Furthermore, when encrypting the cookie, it will be difficult to edit the cookie so that the result of correlations may not be manipulated by the user or a third party further increasing the reliability of the results of the comparison between business location data and mobile device location data.

Additionally, the user may obtain, for example together with the advertisement information, an electronic voucher or code which entitles the user to a discount when visiting the business associated with advertisement information. Encryption of the electronic voucher or code is also preferable to avoid tempering with the discount scheme.

Several techniques may be used to determine whether the user visiting the business associated with the advertisement information actually buys something. For example, near field communication (NFC) may be incorporated in the mobile device and may be used for purchasing by providing a contactless mechanism to detect the price of a product with a contactless chip and/or pay the price at a payment terminal using a mobile phone, for example. Further, also radio frequency identification (RFID) is compatible with NFC and may be used in combination with NFC. Additionally, similar to NFC, Bluetooth may be used to download data in a store or at a data terminal or a barcode reader may be used to read the price of a product. To determine the price and carrying out payment, NFC however may be preferable over Bluetooth since its short range of about 10 cm enables to better define the area of wireless communication.

Therefore, there are several possibilities of determining a reward paid by the business to the network operator or advertiser, for example by counting the number of matches between mobile device locations and business locations, when repeating the steps of the above described method, e.g. for several hours or days; determining the time spent in the store of the business owner; determining if the user keeps coming back; and determining whether the user bought something in the store. Further, advertisement information of competing stores may be provided if the user browses the Internet while in the store to attract the user to a different store.

As indicated above, the provided advertisement information may be dependent on the location of the mobile device, for example only advertisement information of businesses in the city may be provided, in which the user is currently in or businesses at a distance of up to 2 km of the user. Therefore, the probability of the user being interested in the advertisement information is increased. This probability is further increased if the provision of advertisement information is effected upon the user's request for information. As mentioned above, the user may carry out a search on a web browser regarding a particular business located in the vicinity or whole city the user is in.

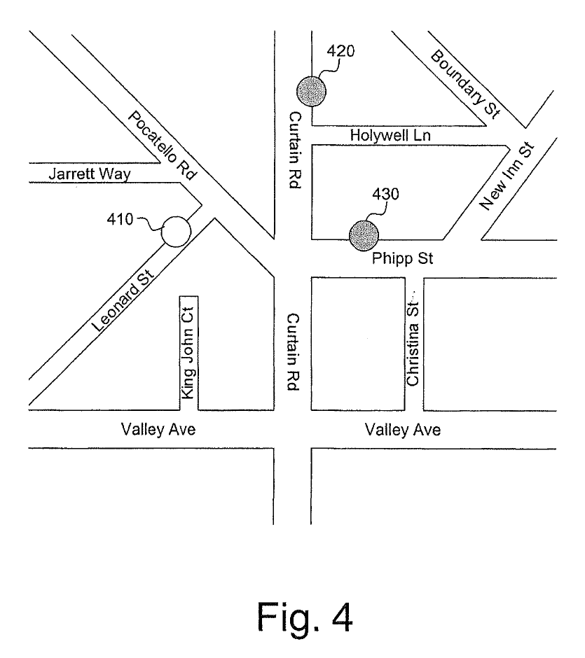

For example, a user may operate his/her mobile device at position 410 on Leonard St, as indicated in FIG. 4. In detail, the user may search for a hardware store by using a search engine and browsing a location service or sites where hardware stores advertise on a web browser of the mobile device. In the example of FIG. 4, hardware stores 420 and 430 are found on Curtain Rd and Phipp St, respectively. If the user goes to the hardware store 420 on Curtain Rd, the movement pattern of the user may be detected and compared to business location data associated with the advertisement information so that a match between the location of the hardware store 420 and the location of the user may be detected.

According to another specific embodiment, the businesses, e.g. the two hardware stores 420 and 430, shown by the web browser, are written to an encrypted cookie on the mobile device, and also their locations may be written to the encrypted cookie by using Geotags of the hardware stores, for example. When the user of the mobile device now enters one of the businesses, the mobile device using its GPS application may determine a match with the coordinates stored in the cookie and the match or the user's location may be written into the cookie. Then the cookie is forwarded to a server for managing the matches and for accounting so that the advertiser that provided the advertisement information gets paid for driving traffic to the business and/or a commission on what the user actually buys, which may be determined using the NFC technique described above. In detail, if the user buys something via NFC, a share price may be reserved to make the user pay with NFC so as to be able to automatically track the purchasing process electronically.

Therefore, even owners of small businesses have the opportunity to achieve effective low cost advertising geared towards the interest of a mobile device user and the physical location of the mobile device user. In particular, the effectiveness of information provision may be determined automatically and objectively, i.e. it may be easily verified whether a user follows a proposal.

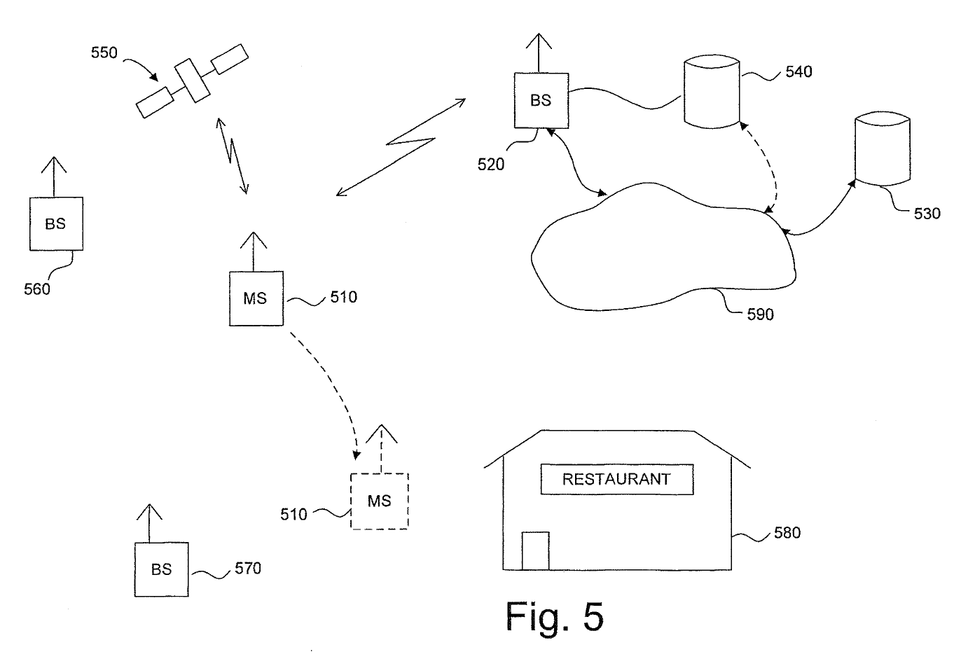

Next, another practical example using the above discussed method and/or mobile device is explained with respect to FIG. 5. In particular, FIG. 5 illustrates a mobile phone (mobile station MS) 510 changing its position indicated by dashed lines, several base stations (BS) 520, 560 and 570, a satellite 550, a business 580 and servers 530 and 540, wherein server 530 is connected to the base station 520 through the Internet 590.

In this example, the mobile phone 510 communicates with the base station 520 via a known mobile communication technique, such as GPRS or UMTS to obtain information from the server 530 through the Internet 590. In FIG. 5, the network infrastructure has been simplified leaving out several nodes and gateways, which may be necessary for connecting to the Internet, such as a serving GPRS support node (SGSN), gateway GPRS support node (GGSN), etc. in case of GPRS, or a base station controller (BSC).

Here, the mobile phone may receive repeatedly advertisement information via the short messaging service (SMS) or the user of the mobile phone may connect to the Internet 590 and browse for information regarding nearby restaurants that may be obtained from server 530.

Once the mobile phone 510 obtains advertisement information, the advertisement information is provided to the user of the mobile phone visually via a display and/or via sound.

The user carrying the mobile phone 510 may then decide to visit one of the advertised businesses, for example restaurant 580, and subsequently move in the direction of restaurant 580. Using GPS signals provided by satellites 550, one of which is shown for illustrative purpose, movement pattern of the user of the mobile phone 510 may be monitored and stored in the mobile phone 510. For example, a GPS device in the mobile phone 510 determines the position of the user every two minutes to derive the movement pattern of the user.

Alternatively or additionally, location determination of the mobile phone 510 may be carried out by triangulation using the base stations 520, 560 and 570, as indicated in FIG. 5. Other systems for determining the location include a system by a company called Rosum proposing the usage of digital, analog and mobile broadcast TV signals for triangulating location, which can travel through walls and thus may provide positions indoors.

Furthermore, the location may be determined by methods which provide an indirect measurement of the location, e.g. when using NFC, barcode, etc., i.e. when the user pays at a certain location with the mobile device, e.g. in a business, or scans an item in at the business, it is possible to derive his/her location if the location of the business, i.e. location of a reader in the business, such as a transaction terminal, is known. For example, if a user pays via mobile phone at the subway, e.g. with NFC or barcode, it is possible to get the location of the user, such as a particular subway station, if the location of the reader is mapped. In the cases of paying by using NFC, GPS or other direct location services are not needed, since a location match may be obtained by using the known location of the reader.

Surely hybrid systems may also be used combining two or more of the above mentioned positioning methods to increase the accuracy.

As described above, the comparing section 240 of the mobile device, i.e. in this example the mobile phone 510, compares repeatedly, for example every two minutes, once new mobile device location data is obtained, the obtained mobile device location data with business location data.

In the above example, it has been assumed that the location of the business, e.g. restaurant 580, is fixed. However, the business may be a mobile business changing its position, like an ice-cream van. In such a case, the association between advertisement information and business location data has to be repeatedly updated, since the business location data is repeatedly changing. Therefore, similar position mechanisms, as discussed with respect to the mobile phone 510, may be used for the business. For example, the location may be determined by GPS and this location may be provided to the server 540 repeatedly via mobile communication to update the look-up table maintaining the association. Consequently, the network shown in FIG. 5, and in particular the server 540, receives repeatedly new locations of the business so that the association may be dynamically changed.

FIG. 6 illustrates a network server for evaluating a correlation between advertisement information related to advertised goods or services and the behavior of a user having received the advertisement information. The network server may be any kind of server in a communication network, e.g. server 540 of the communication network in FIG. 5 and its elements and their functions are described in detail below with respect to FIG. 6. In detail, the network server 600 of FIG. 6 comprises an information providing unit 610, a storage unit 620, a location obtaining unit 630, a comparing unit 640, and a registering unit 650. These elements are connected, similarly to the elements of the mobile device in FIG. 2, to achieve the herein discussed functions.

In more detail, the information providing unit 610 provides advertisement information to the mobile device of the user. For example, the information providing unit 610 is connected to the Internet to provide the mobile device with search results. Further, a storage unit 620 is provided in the network server 600. The storage unit 620 stores an association between the advertisement information and business location data indicative of at least one location of a business, where goods or services subject to advertisement information are available for purchase.

The location obtaining unit 630 of the network server 600 obtains mobile device location data about the current location of the mobile device. For example, the location obtaining unit 630 may communicate with a mobile device, and in particular with a GPS application of the mobile device, to obtain the current location of the mobile device, as described above. However, preferably, the network server may also obtain mobile device location data without contacting the mobile device directly, namely by contacting one or more base stations, such as base stations 520, 560 and 570 in FIG. 5, to obtain the location of the mobile device, e.g. mobile phone 510, by simply determining the cell serving the mobile phone or by triangulation.

It is noted that determining a cell for obtaining location may also be applicable to wireless local access networks (WLAN) also providing nodes which are connected to the mobile device dependent on the location of the mobile device. Furthermore, the information about the location of the mobile device may additionally be used for providing suitable advertisements to the mobile device. Additionally, by using the current location of the mobile device without having to query the mobile device and sending this information through the network, better data privacy can be ensured, since all information about the user is kept on the network server.

Subsequently, the comparing unit 640 compares the mobile device location data with the business location data indicative of the at least one location of the business, similar to the comparison performed in the mobile device 200 discussed above.

If the comparing unit 640 determines that the mobile device location matches with a business location indicated in the business location data, the match is registered.

Additionally, the network server 600 may comprise a counting unit for counting the number of matches between mobile device locations and business locations to determine a possible reward for an advertiser, as discussed above.

Therefore, similar advantages as described above with respect to the method of FIG. 1 and the mobile device of FIG. 2 can be achieved. Particularly, it can be seen that the functions of the network server are similar to the functions of the mobile device, whereas the network server 600 may evaluate a correlation between the advertisement information and the user behavior without the support of the mobile device except that advertisement information provided from the network server 600 to the mobile device 200 has to be brought to the attention of the user of the mobile device.

Having shown that similar advantages may be achieved independently by a mobile device and a network server having similar functions, it should be clear that the functions of the sections of the mobile device and the functions of the units of the network server can be intermixed.

For example, the same advantages may be achieved with a mobile device comprising the information providing section 210, the business location data receiving section 220, a storage section for storing an association between advertisement information and business location data and a location obtaining section 230, and a network server comprising the information providing unit 610, the location obtaining unit 630, the comparing unit 640 and the registering unit 650, wherein the location obtaining unit 630 interacts with the mobile device to obtain the location.

In this case, the mobile station location data and the business location data associated with the advertisement information may be provided from the mobile device to the network server, which performs the comparison. Similarly, the storage section of the mobile device may be removed and the storage unit 620 may be included in the network server which maintains the same association as the storage section previously so that the comparing unit 640 may again provide the same results. Alternatively, mobile station location data and the business location data may be obtained at the network server without the support of the mobile device, as discussed above, and this data may be transmitted to the mobile device which carries out the comparison.

Therefore, a system may be provided comprising a mobile device and a network server each comprising some of the above mentioned functions.

As known by the skilled person, several functions of the mobile device 200 may be incorporated and carried out in a controller comprising a CPU, such as the functions of the comparing section and the registering section. Particularly, the different sections of the mobile device 200 may be realized at least partly by a hardware arrangement, for example, comprising hardwired circuits or ASICs (application specific integrated circuits) or software or any suitable combination of the above. Similarly, also the functions of the units of the network server 600 may be incorporated and carried out in a controller, at least partially, and realized by a hardware arrangement, software or a combination thereof.

The terms “unit” and “section” in the above described embodiments should not be construed as limiting the individual elements to a separate tangible part of the network server or mobile device but should be understood as a kind of functional entity.

Further, the functions of the sections and units may be controlled by a controller including a processor, whereas at least some functions may be realized by running suitable software stored in a memory of the mobile device or network server 600, such as the storage section or storage unit 620.

As described above, a controller may be integrated in the mobile device 200 and the network server 600 and connected to a memory, such as a RAM, ROM, hard disk, (E)EPROM, a disk, a flash memory or a suitable combination thereof. For example, program code stored in the memory may be a software program including instructions adapted to cause the processor of the controller to carry out the above described method steps and functions.

In other words, a program may be provided including instructions adapted to cause a processor, such as the processor of the above mentioned controller, to carry out combinations of the above described method steps.

Moreover, a computer readable medium may be provided in which the program is embodied. The computer readable medium may be tangible, such as a disc or other data carrier, or may be intangible, constituted by signals suitable for electronic, optic or any other type of transmission. A computer program product may comprise the computer readable medium and when loaded into a program memory of a computer, processor or microcontroller causes the processor or microcontroller to carry out the above described operations.

It will be appreciated that various modifications and variations can be made in the described mobile devices, network servers and methods as well as in the construction of this invention without departing from the scope or spirit of the invention.

The invention has been described in relation to particular embodiments which are intended in all aspects to be illustrative rather than restrictive. Those skilled in the art will appreciate that many different combinations, hardware, software and firmware will be suitable for practicing the invention.

Moreover, other implementations of the invention will be apparent to the skilled person from consideration of the specification and practice of the invention disclosed herein. It is intended that the specification and the examples be considered as exemplary only. To this end, it is to be understood that inventive aspects lie in less than all features for the foregoing disclosed implementation or configuration. Thus, the true scope and spirit of the invention is indicated by the following claims.

1. A method for evaluating a correlation between advertisement information related to advertised goods or services and the behavior of a user having received said advertisement information, comprising the steps
providing advertisement information to the user;
maintaining an association between said advertisement information and business location data indicative of at least one location of a business, where goods or services subject to advertisement information are available for purchase;
obtaining mobile device location data about the current location of a mobile device of the user after said advertisement information has been provided;
comparing said mobile device location data with said business location data indicative of said at least one location of the business; and
if the comparing step determines that said mobile device location matches with a business location indicated in said business location data, registering the match.

2. The method of claim 1, further comprising the step
storing at least one of said provided advertisement information and said business location data in the mobile device or network servicing the mobile device to keep track of the previously provided advertisement information.

3. The method of claim 1, wherein at least one of said provided advertisement information and said business location data is stored in a cookie in said mobile device.

4. The method of one of claim 1, wherein the step of registering the match comprises
writing an indication of the match into a cookie; and the method further comprises
sending the cookie from said mobile device to a network server.

5. The method of one of claim 2, wherein the advertisement information is stored in encrypted form.

6. The method of one of claim 1, wherein the advertisement information is provided based on the location of the mobile device.

7. The method of one of claim 1, further comprising the step
providing advertisement information regarding a particular business upon user request.

8. The method of one of claim 1, further comprising the step
counting the number of matches between mobile device locations and business locations, wherein a reward paid by the business depends on the number of matches.

9. The method of one of claim 1, further comprising the step
repeatedly updating the association between said advertisement information and business location data.

10. A mobile device for evaluating a correlation between advertisement information related to advertised goods or services and the behavior of a user having received said advertisement information, comprising
an information providing section for providing advertisement information to the user of said mobile device, wherein said advertisement information is associated with business location data indicative of at least one location of a business, where goods or services subject to advertisement information are available for purchase;
a business location data receiving section for receiving business location data associated with said provided advertisement information;
a location obtaining section for obtaining mobile device location data about the current location of the mobile device;
a comparing section for comparing said mobile device location data with said business location data indicative of said at least one location of the business; and
a registering section for registering a match, if the comparing section determines that said mobile device location matches with a business location indicated in said business location data.

11. The mobile device of claim 10, further comprising
a first storage section for storing at least one of said provided advertisement information and said business location data in the mobile device or network serving the mobile device to keep track of the previously provided advertisement information.

12. The mobile device of claim 10, further comprising
a second storage section for storing an association between said advertisement information and business location data.

13. The mobile device of claim 10, wherein
said mobile device is a mobile phone operating in a mobile communication network.

14. A network server for evaluating a correlation between advertisement information related to advertised goods or services and the behavior of a user having received said advertisement information, comprising
an information providing unit for providing advertisement information to a mobile device of the user;
storage unit for storing an association between said advertisement information and business location data indicative of at least one location of a business, where goods or services subject to advertisement information are available for purchase;
a location obtaining unit for obtaining mobile device location data about the current location of the mobile device;
a comparing unit for comparing said mobile device location data with said business location data indicative of said at least one location of the business; and
a registering unit for registering a match, if the comparing unit determines that said mobile device location matches with a business location indicated in said business location data.

15. A network server of claim 14, further comprising
a counting unit for counting the number of matches between mobile device locations and business locations.

16. A computer program product, which when loaded into program memory of a processor or microcontroller, causes the processor or microcontroller to carry out the method of claim 1.
